(19) United States
(12) Patent Application Publication
(10) Pub. No.: US 2026/0266726 A1
(43) Pub. Date: Sep. 10, 2026

(54) ANALYSIS DEVICE

(71) Applicant: NATIONAL UNIVERSITY CORPORATION KOBE UNIVERSITY, Kobe-shi (JP)

(72) Inventor: Hiroshi ITO, Tokyo (JP)

(21) Appl. No.: 19/166,685

(22) PCT Filed: Mar. 19, 2024
(86) PCT No.: PCT/JP2024/010839

§ 371 Date: Sep. 18, 2025

(30) Foreign Application Priority Data
Mar. 20, 2023 (JP) 2023-044723

(51) Int. Cl. G01N 21/64

(52) U.S. Cl. CPC G01N 21/645

(57) ABSTRACT

An analysis device includes a detection unit that detects a pulse signal from an optical sensor, and an analysis unit that performs analysis in relation to a radiation source that is a measurement target and an emission source. The detection unit detects a first pulse signal upon receipt of excitation emission of the gas molecules generated from the radiation at a time at which the radiation is emitted from the measurement target, and second pulse signal upon receipt of light emitted by avalanche amplification of a group of the secondary electrons each time that the secondary electrons move to an anode while maintaining a trajectory of radiation due to the electric field and group of secondary electrons arrives at the anode. The analysis unit estimates a generation position of the radiation source based on a time difference between the first pulse signal and pulse signals.

### TECHNICAL FIELD

The present disclosure relates to an analysis device for analyzing radiation.

### BACKGROUND ART

A technique for detecting electronic signals exists. Further, a technique relating to radiation detectors that utilize the phenomenon of gas luminescence due to radiation (gas scintillation) exists.

A technique related to a mechanism for counting secondary electrons emitted from a substrate surface exists (see Patent Document 1: Japanese Patent Application Laid-open No. 2012-68196). In this technique, as a mechanism, an aspect is disclosed that has a scintillator that converts secondary electrons into light energy, a photomultiplier tube that amplifies the light energy into an electrical signal, and a pulse height discriminator that counts the number of pulses of a secondary electron signal amplified by the electrical signal.

Further, a beam measurement technique exists for improving the accuracy of void size measurements in thin-film materials using slow positron pulse beam lifetime measurement (Patent Document 2: Japanese Patent Application Laid-open No. 2011-27528). In this technique, positron annihilation gamma rays are irradiated onto a porous material body to which an electric field is applied in a vacuum, and electrons emitted from the pore walls into the vacuum owing to the gamma ray irradiation are directly detected. This technique discloses an aspect that performs measurement of a time difference between a time of incidence of a positron into the sample, and a time of positron annihilation with an electron within the sample.

Further, a technique exists in which secondary electrons emitted from the irradiation position of the primary electron beam on the sample are collided with a scintillator to generate photons, which are then photoelectrically converted, and the pulse signal is counted (Patent Document 3: Japanese Patent Application Laid-open No. 2000-133193).

As a technique for detecting radiation, a time projection chamber (TPC) exists. Regarding mechanisms using TPC technology, a technique exists for ultra-low radioactivity alpha-ray analysis that utilizes the property that electrons are generated when alpha rays react with gas (see Non-Patent Document 1: Hiroshi Ito, Hirohisa Ishiura, Kiseki D. Nakamura and Kentaro Miuchi, “A progress of upgrading α-ray imaging chamber in a low background radioactivity”, Journal of Physics: Conference Series: 26 Aug.-3 Sep. 2021, Valencia). Further, a technique exists for radiation tracking detectors using GEM+CMOS sensors (see Non-Patent Document 2: Abritta Costa et al., “Performance of optically readout GEM-based TPC with a ⁵⁵Fe source”, 2019 JINST 14 P07011 .)

### SUMMARY OF THE INVENTION

### Problem to be Solved by the Invention

FIG. 1 is an image diagram of an aspect of alpha-ray generation. When radon in the air turns into polonium (Po) and adheres to the surface of a sample, an alpha ray is generated. Alpha rays emitted by Po attached to the sample include surface alpha rays and bulk alpha rays within a few microns from the surface. The energy spectra of these alpha rays can be distinguished as monochromatic energy for surface alpha rays and continuous energy distribution for bulk alpha rays. Therefore, from the energy spectrum, it can be determined whether radioactive contamination is only at the surface or whether the interior of the material is also contaminated.

There is demand for a mechanism capable of analyzing the above-described alpha rays with high precision. For example, radiation detectors for underground experiments are required to be enlarged and to contain as few impurities as possible. Even minute amounts of radioactive contamination on the surface of a material can pose a major problem in underground experiments. Specifically, in a case in which a sample surface is contaminated during a full-scale test using a high-purity germanium semiconductor gamma-ray detector or the like, the radiation may be underestimated. Therefore, there is demand for a technique that enables highly accurate analysis even with minute amounts of radiation.

Further, for example, a solder material for joining a semiconductor device to a substrate contains a very small amount of radioactive material, which emits alpha rays. The emitted alpha rays can adversely affect the operation of a semiconductor device. Further, as semiconductor devices are further miniaturized, their resistance to radiation weakens.

Therefore, there is demand for materials with extremely low alpha-ray emission (ultra-low alpha materials), as well as for devices that can measure and analyze even minute amounts of alpha rays with high accuracy.

As a detection device for detecting alpha rays, there is a detection device using a TPC. With a TPC alone, it is possible to construct a three-dimensional track of a charged particle; however, it is not possible to discern the z-coordinate of the position at which the alpha rays are generated. This is, in particular, because while radon is a radioactive substance that occurs everywhere in nature, and the z-coordinate of the position at which alpha rays are emitted from a generation source (ray source) that generates radiation is constant, alpha rays originating from radon are uniformly present inside the TPC vessel.

If it is possible to distinguish between the generation of alpha rays from the measurement target originating from a generation source and the generation of alpha rays originating from radon by using gas scintillation, it is thought that by combining this with TPC, even trace amounts of alpha rays can be measured with high accuracy.

The present disclosure has been made in consideration of the above-described circumstances, and aims to provide an analysis device using gas scintillation, the analysis device being able to analyze the generation source of even minute amounts of radiation with high accuracy.

### Means for Solving the Problem

In order to achieve the above-described object, the analysis device according to the present disclosure includes: a gas that emits scintillation light, and that ionizes to generate secondary electrons, under the action of gas molecules and radiation in a container; a predetermined optical sensor that generates a pulse signal in response to receiving the scintillation light; a detection unit that detects the pulse signal generated by the optical sensor; an electrical field that transports the ionized secondary electrons in the container; and an analysis unit that, based on the pulse signal, performs analysis in relation to a radiation source that is a measurement target and that is a generation source of the radiation, and an anode electrode is provided that is disposed in a direction in which the secondary electrons are transported and that detects the secondary electrons. The detection unit detects a first pulse signal generated by the optical sensor upon receipt of excitation emission of the gas molecules generated from the radiation at a time at which the radiation is emitted from the measurement target, and detects a second pulse signal generated by the optical sensor upon receipt of light emitted by avalanche amplification of a group of the secondary electrons each time that the secondary electrons move to the anode electrode while maintaining a trajectory of the radiation as a result of the electric field and the group of secondary electrons, which is track-shaped, arrives at the anode electrode. The analysis unit, as the analysis, estimates a generation position of the radiation source based on a time difference between the first pulse signal and an end of the second pulse signal.

### Effect of the Invention

According to the analysis device of the present disclosure, the analysis device uses gas scintillation, and has the effect of being able to analyze a generation source of even minute amounts of radiation with high accuracy.

### BRIEF EXPLANATION OF THE DRAWINGS

FIG. 1 is an image diagram of an aspect of alpha ray generation.

FIG. 2 is a diagram showing a schematic configuration of an analysis device according to the present embodiment.

FIG. 3 is an example of imaging of a two-dimensional hit map obtained by detecting secondary electrons with a μ-PIC.

FIG. 4 is a diagram showing an example of the energy distribution of alpha rays observed with a μ-PIC.

FIG. 5 is an image diagram of alpha ray transition and excitation emission.

FIG. 6 is a diagram showing an outline of a case of comparison of detection by a photomultiplier tube and by a μ-PIC.

FIG. 7 is an image diagram of a case in which signal detection events are accumulated and a signal originating from a radiation source and a signal originating from radon are distinguished and compared.

FIG. 8 shows an example of a μ-PIC signal and a photomultiplier tube signal obtained by verification.

FIG. 9 is a histogram of the frequency of pulse heights for a signal s1.

FIG. 10 is a histogram of the frequency of integrated charge for a signal s2.

FIG. 11 is a heat map comparing s1 and s2.

FIG. 12 shows the number of events at the peak time of s1.

FIG. 13 shows the signal counts over a range of time differences measured for a short period of time using a strong radiation source.

FIG. 14 shows the signal counts over a range of time differences measured for a long period of time using a weak radiation source.

FIG. 15 is an image diagram showing examples of groups of secondary electrons having track shapes in different radiation directions.

FIG. 16 shows the signal counts over a range of time differences measured for a short period of time using a strong radiation source with an increased statistical amount.

FIG. 17 shows the signal counts over a range of time differences measured for a long period of time using a weak radiation source with an increased statistical amount.

### BEST MODE FOR CARRYING OUT THE INVENTION

Embodiments of the present disclosure are explained in detail below with reference to the drawings.

First, the technique used in the embodiments of the present disclosure is explained.

A TPC (time projection chamber) is a detector that three-dimensionally reconstructs the tracks of charged particles that pass through a sensitive region filled with an inert gas such as a rare gas. Specifically, the TPC transports electrons generated when alpha rays pass through a static electric field to a track-reading anode substrate (anode electrode) such as a micropixel chamber (μ-PIC), records the two-dimensional hit location and time, and converts the time to a z-coordinate and performs reconstruction as a three-dimensional track. A TPC using a μ-PIC is a high-precision alpha ray imaging detector with a detection limit of ~10⁻³a/cm²/h. The z-coordinate position is calculated by z=dt·v using a drift velocity v and a time difference dt. The derivation of the drift velocity v and the time difference dt in the present embodiment is described below. Identifying z-coordinate positions and reconstructing three-dimensional tracks are examples of performing source-related analysis according to the present disclosure.

Further, as described above in relation to the problem of the invention, the z-coordinate of the position at which alpha rays are generated from a source (radiation source) that generates radiation is constant. Further, alpha rays originating from radon are uniformly present inside the TPC vessel and the alpha rays are emitted isotropically. If the z-coordinate of the alpha-ray generation position of the generation source can be determined, alpha rays originating from radon can be suppressed.

Explanation follows regarding an example of an exemplary embodiment of the present disclosure, with reference to the drawings. Here, in the respective drawings, the same reference numerals are allocated to the same or equivalent configuration elements and parts. Further, in the drawings, the scale may be exaggerated to aid explanation and thus may differ from actual dimensions.

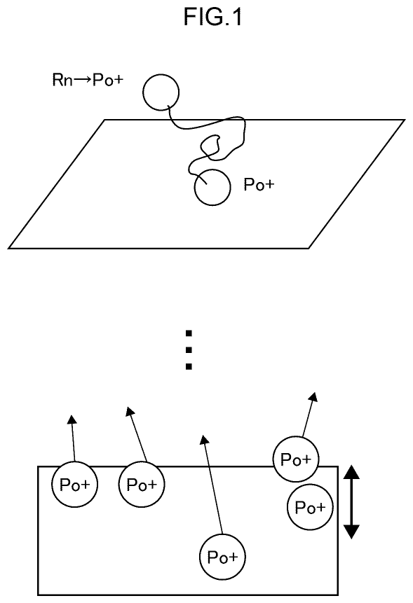

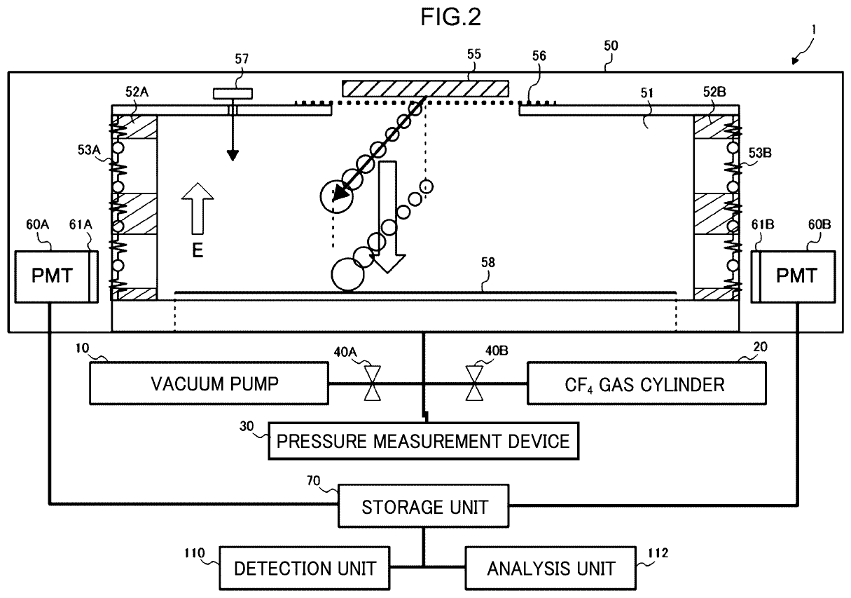

FIG. 2 is a diagram showing a schematic configuration of an analysis device according to the present embodiment. The analysis device 1 for analyzing radiation shown in FIG. 2 includes a vacuum pump 10, a CF₄ gas cylinder 20, a pressure measurement device 30, valves 40A, 40B, a housing 50, photomultiplier tubes (PMT) 60A, 60B, a storage unit 70, a detection unit 110, and an analysis unit 112. Further, a μ-PIC (anode electrode 58) for detecting secondary electrons is provided in the housing 50 and is disposed in the direction in which the secondary electrons are transported. The anode electrode 58 can be adapted for any given readout substrate, such as μ-PIC, GEM, or GEM+CMOS sensors. In the following explanation, a case is exemplified in which the anode electrode 58 is a μ-PIC. Here, in a case in which the anode electrode 58 is a GEM+CMOS sensor, the device configuration exemplified in Non-Patent Document 2 can be applied. In the device configuration shown in FIG. 1 of Non-Patent Document 2, GEM and CMOS sensors (document (D) portion) are installed at a sensitive volume (document (A) portion), which corresponds to the housing 50, for example. The GEM and CMOS sensors correspond to the anode electrode 58 of the present disclosure. The detection unit 110 and the analysis unit 112 can be realized by an information processing device such as a personal computer equipped with, for example, a CPU (Central Processing Unit), ROM (Read Only Memory), RAM (Random Access Memory), storage, and the like. Here, for ease of explanation, there are cases in which the reference numerals for components such as photomultiplier tubes and μ-PICs are omitted.

The vacuum pump 10 is a pump for discharging gas from within the housing 50, and the valve 40A prevents gas discharged from the housing 50 from flowing back. The pressure measurement device 30 measures the air pressure inside the housing 50. As the pressure measurement device 30, a diaphragm vacuum gauge that detects displacement as capacitance is used, for example. By checking the air pressure measured by the pressure measurement device 30, it can be discerned whether or not the inside of the housing 50 is in a vacuum state.

The CF₄ gas cylinder 20 supplies CF₄ (carbon tetrafluoride) gas to the housing 50 that has been put in a vacuum state. In the present embodiment, the atmospheric pressure of the CF₄ in the housing 50 is 0.2 atmospheres. Further, the atmospheric pressure can be any given pressure such as from 0.1 to 1.2 atmospheres.

The housing 50 contains a measurement target 55 that is the target of radiation analysis. The radiation source in the present embodiment is the measurement target 55 and is the generation source of alpha rays. In the present embodiment, the housing 50 has a rectangular shape with a height of 15 cm and a width of 35 cm; however, the present disclosure is not limited to this example, and the housing may be cylindrical in shape, for example. Within the container of the housing 50, an electric field E exists that transports the ionized secondary electrons.

Further, in the present embodiment, the radiation measurement target 55 is a copper plate, and one to which a naturally occurring radioactive material, such as the polonium-210 radioactive isotope, has been attached, is used. A copper plate with this polonium-210 radioisotope attached to the surface thereof emits monochromatic alpha rays at 5.3 MeV.

The measurement target 55 is placed on a placement part 56 configured by copper mesh. In the present embodiment, the measurement target 55 placed on the placement part 56 is the generation source of alpha rays, and the analysis unit 112, which is described below, analyzes the z-coordinate of the generation position of the generation source. The housing 50 is equipped with a mechanism that is provided with an injection part, and that enables placement of a radiation source 57 having polonium 210 attached to a surface thereof, whereby alpha rays (arrow) from the radiation source 57 are input from the injection part. This mechanism enables the performance of the analysis device 1 to be monitored simultaneously with sample analysis.

Further, the inside of the housing 50 is filled with CF₄ gas (gas 51) supplied from a CF₄ gas cylinder 20A. The CF₄ gas is an example of an inert gas, and the interaction of CF₄ gas molecules with radiation causes the emission of scintillation light. The housing 50 is provided with Teflon (registered trademark) walls 52A, 52B with window frames attached, and resistance chains 53A, 53B. The emitted scintillation light passes through the window frames in the Teflon (registered trademark) walls 52A, 52B and arrives at the photomultiplier tubes 60A, 60B.

In the present embodiment, the housing 50 is filled with CF₄ gas; however, the present disclosure is not limited to this example. The gas 51 filling the housing 50 may be an inert gas such as argon gas, neon gas, or xenon gas.

The photomultiplier tubes 60A, 60B are examples of the optical sensor of the present disclosure, and are particularly suitable for detecting weak light. The photomultiplier tubes 60A, 60B are respectively provided with photocathodes 61A, 61B. The photocathodes 61A, 61B are electrodes that convert the scintillation light generated within the housing 50 into electrons. The photomultiplier tubes 60A, 60B amplify the electrons converted by the photocathodes 61A, 61B and output them as a pulse signal. The photomultiplier tubes 60A, 60B are examples of a predetermined optical sensor that generates a pulse signal in response to receiving scintillation light according to the present disclosure.

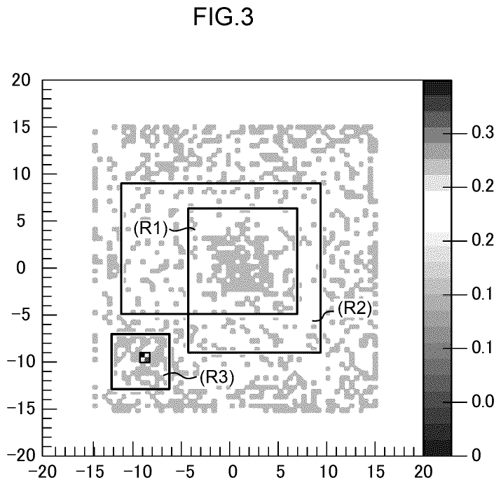

FIG. 3 is an example of imaging of a two-dimensional hit map obtained by detecting secondary electrons with a μ-PIC. The μ-PIC is a strip-type readout device that can simultaneously read anode and cathode signals and determine the hit position at 400 μm intervals. The height is set as the anode (30 cm), the width as the cathode (30 cm), and the sample area of the measurement object 55 as 15×15 cm². In the measurement target 55, a sample region (R1) and a background region (R2) are enclosed by lines. Further, the lower left is a region (R3) of the alpha ray source at the injection part.

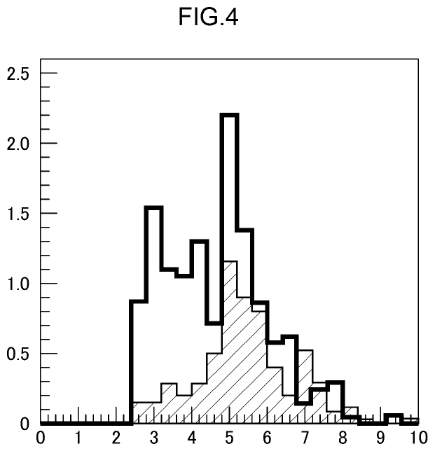

FIG. 4 is a diagram showing an example of the energy distribution of alpha rays observed with a μ-PIC. In the graph of FIG. 4, the horizontal axis indicates the energy of alpha rays, and the vertical axis indicates the number of counts per unit time. The histogram with a patterned background is obtained by measurement of the background area (R2) surrounded by a line. The histogram with a plain background is obtained by measurement of the sample area (R1). Comparing the histograms, it can be seen that a statistically significant signal exists in the sample region (R1) as compared to the background region (R2). Here, since the difference between the two is a continuous distribution, it is understood that bulk alpha rays are being observed. Further, in a case in which bulk alpha rays are not observed, the histogram distributions are almost the same.

The storage unit 70 stores the pulse signals generated by the photomultiplier tubes 60A, 60B during a predetermined period in a state in which the radiation measurement target 55 is present within the housing 50.

The detection unit 110 detects the generation of radiation by the measurement target 55 based on the pulse signals output by the photomultiplier tubes 60A, 60B. In the present embodiment, the detection unit 110 detects a first pulse signal and, in addition, detects a second pulse signal. The first pulse signal is a signal generated by the photomultiplier tubes 60A, 60B that have received excitation emission of gas molecules generated by radiation at the time that the radiation was emitted from the measurement target 55. The second pulse signal is a signal that maintains a duration as track-shaped information. It is a signal generated by the photomultiplier tubes 60A, 60B that have received light from a group of secondary electrons that has been avalanche amplified and emitted light each time that a track-shaped group of secondary electrons is moved to the anode electrode by the electric field while maintaining the trajectory of the radiation, and then, the track-shaped group of secondary electrons reaches the μ-PIC (anode electrode 58). The response time of the electrical signal from the anode electrode is about 10⁻⁶ seconds and the response time of the optical signal is about 10⁻⁹ seconds. Therefore, the speed of the response time has a large effect on the accuracy of determining the drift distance. For these reasons, in the method of the present embodiment, by using the second pulse signal of the optical signal having a fast response time to perform detection of the end, the drift distance can be detected with high accuracy using the second signal.

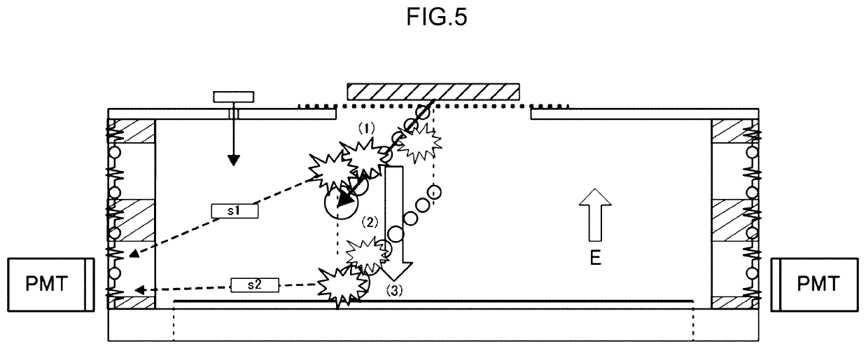

Here, FIG. 5 is an image diagram of alpha ray transition and excitation emission. (1) Alpha rays are emitted from the measurement target 55. The alpha rays pass through the mesh gaps of the placement part 56 and enter the housing 50. Gas molecules along the trajectory are ionized and secondary electrons are produced. In conjunction with the generation of secondary electrons, excitation emission occurs simultaneously, and the first pulse signal s1 is observed in the photomultiplier tubes 60A, 60B. (2) A linear electric field is created, and the secondary electrons move in parallel with the electric field. (3) Each time a group of secondary electrons reaches the μ-PIC, avalanche amplification occurs in the vicinity of the anode, and a signal is generated. In conjunction with the avalanche amplification of the group of secondary electrons, excitation emission occurs simultaneously, and the second pulse signal s2 is observed in the photomultiplier tubes 60A, 60B. Anode and cathode signals are output in vertical and horizontal strip-form, resulting in a two-dimensional hit map. Here, for convenience of explanation, only the observation of light emission at the side of the photomultiplier tube 60A is exemplified; however, light emission at the side of the photomultiplier tube 60B is observed in the same manner.

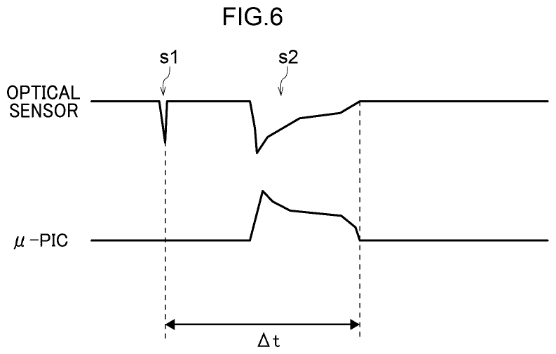

FIG. 6 is a diagram showing an outline of a case of comparison of detection by a photomultiplier tube and by a μ-PIC. In each of the photomultiplier tubes 60A, 60B, the first pulse signal s1 is detected at the time of emission, and each time a track-shaped group of secondary electrons reaches the μ-PIC, the second pulse signal s2 of light emission is detected. Further, the μ-PIC generates a signal when the secondary electrons reach the μ-PIC. As shown in FIG. 6, the second pulse signal s2 corresponds to the signal of the μ-PIC. Here, since the position of the radiation source is fixed, the time difference dt between the peak of the first pulse signal s1 and the end of the second pulse signal s2 is approximately constant. This is because, whatever the angle of radiation of an alpha ray from the measurement target 55, the time until the end reaches the μ-PIC is constant. If the radiation angle is closer to vertical, the distance traveled by the secondary electrons will be shorter, and if it is inclined toward the horizontal direction, the distance traveled by the secondary electrons will be longer. That is, while the second pulse signal is a signal whose starting point and intensity are not constant depending on the emission angle, the position of the end is generally constant. Therefore, the time at which the rear end of the secondary electrons falls on the μ-PIC is important. In the present embodiment, based on this property, the time difference dt between the peak (t0) of s1 and the end point (t1) of s2 is used.

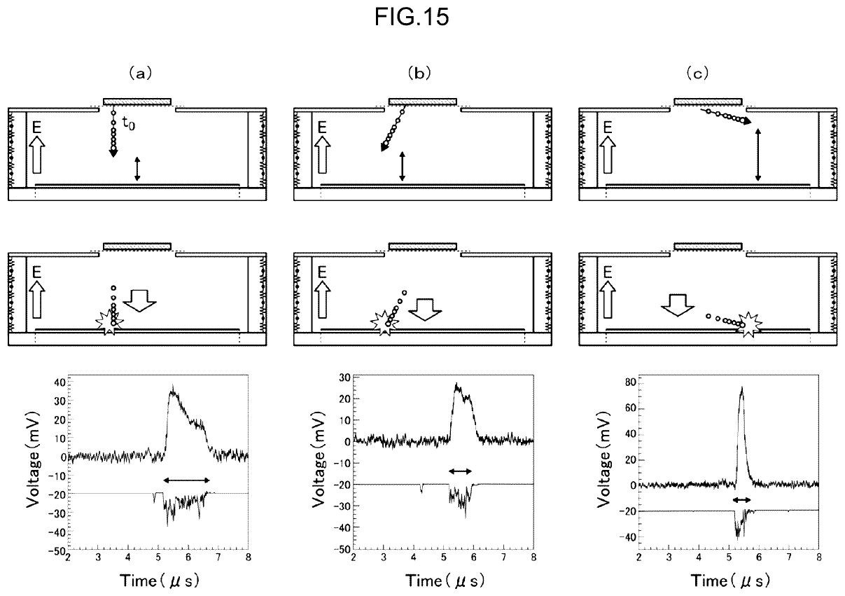

FIG. 15 is an image diagram showing examples of groups of secondary electrons having track shapes in different radiation directions. FIG. 15(a) tracks in a substantially vertical direction, and (b) tracks substantially diagonally to the left. Comparing (a) and (b), the distance traveled by the secondary electrons is relatively shorter in (a). Further, (c) tracks substantially to the right, and the travel distance of the secondary electrons is relatively longer than in either of (a) or (b). From the emission time distribution, information on the length of the electron group in the z-axis direction can be retained, and the termination time can be determined with high accuracy.

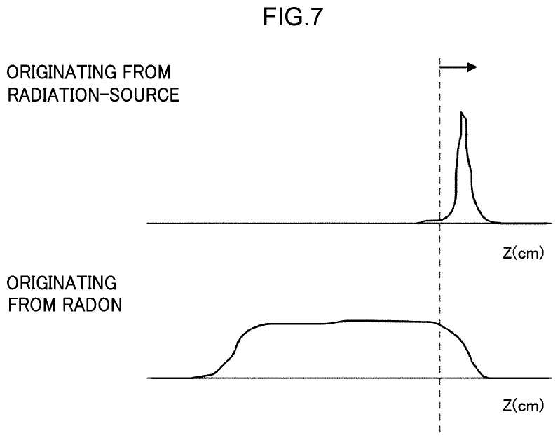

FIG. 7 is an image diagram of a case in which signal detection events are accumulated and a signal originating from a radiation source and a signal originating from radon are distinguished and compared. A signal from radon is detected uniformly, while a signal from the radiation source is detected as a peak.

The analysis unit 112, as analysis, estimates the position of generation as the radiation source of the measurement target 55 based on the time difference dt between the first pulse signal s1 and the second pulse signal s2. The time difference dt is the time difference dt between the peak (t0) of the first pulse signal s1 and the end (t1) of the identified second pulse signal s2.

The time difference dt can be converted to dt=z/v. Therefore, by calculating v=drift velocity, the z-coordinate generation position of the alpha ray source can be estimated.

The analysis unit 112 identifies, for the second pulse signal s2, an end of the signal that is equal to or lower than a preset threshold value, that varies depending on the radiation, and that depends on the direction of radiation. The analysis unit 112 calculates the drift velocity v of the secondary electrons based on the time difference dt, and further, calculates the distance from the anode electrode to the alpha-ray generation point from the drift velocity v and the time difference dt, and estimates the z-coordinate of the radiation source of the measurement target 55.

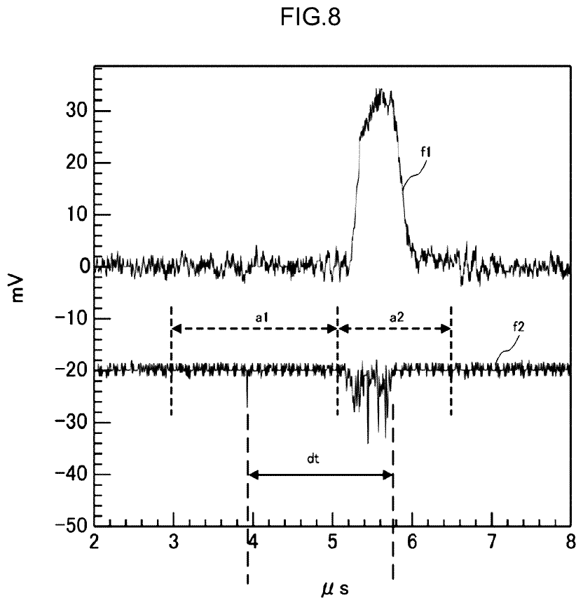

FIG. 8 shows an example of a μ-PIC signal and a photomultiplier tube signal obtained by verification. The vertical axis represents the signal strength mV, and the horizontal axis represents us, showing signal strength against time. The μ-PIC signal is f1, and the photomultiplier tube signal is f2. The range al was set as the analysis range for s1, and the range a2 was set as the analysis range for s2. For al, the time of primary emission and of the peak pulse height were determined. In a2, section integration was performed and the charge was observed. Since the signal s1 is small, no integration is performed. Regarding the signal from the photomultiplier tube, a first pulse signal s1 and a second pulse signal s2 are detected. The peak of s1 and the end of s2 equal to or lower than a preset threshold value can be identified. The peak of s1 and the end of s2 are taken and the time difference dt is obtained.

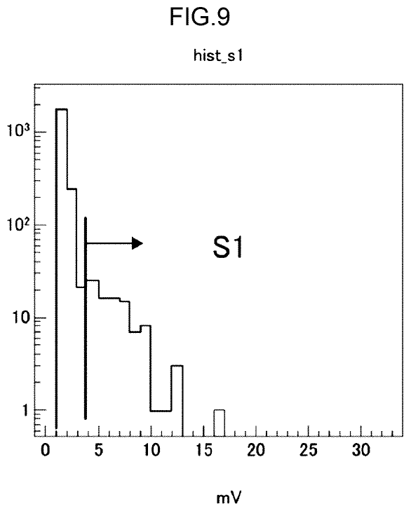

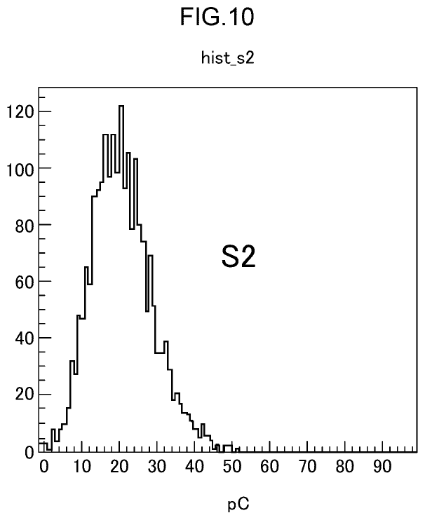

FIGS. 9 to 12 are examples of analysis in relation to the s1 and s2 signals. For s1, the signal before s2 is set as the analysis range. FIG. 9 is a histogram of the frequency of pulse heights for the signal s1. With the vertical axis as the frequency of the number of events, and the horizontal axis as the signal intensity mV of the pulse height of the primary emission, from the distribution of the histogram, a signal with a pulse height intensity of 4 mV or more is determined as s1. FIG. 10 is a histogram of the frequency of integrated charge for the signal s2. The histogram distribution is calculated with the vertical axis as frequency and the horizontal axis as the charge amount pC of the integrated charge of the secondary emission.

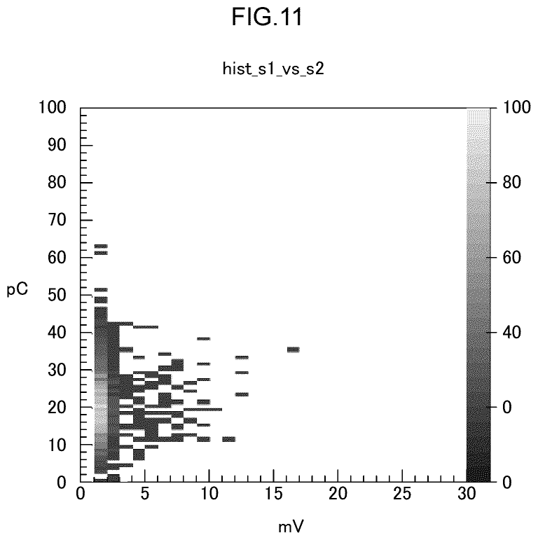

FIG. 11 is a heat map comparing s1 and s2. With the vertical axis as the charge amount pC of the integrated charge of the secondary emission and the horizontal axis as the signal intensity mV of the pulse height of the primary emission, a heat map is represented.

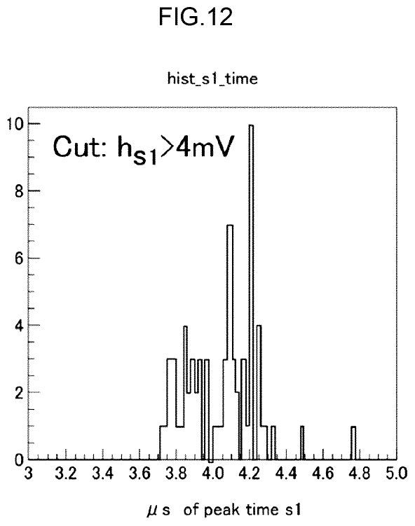

FIG. 12 shows the number of events at the peak time of s1. For s1, the number of events in an analysis range (3-5 μs) satisfying hₛ₁>4 mV is shown.

Further, the detection unit 110 and the analysis unit 112 estimate alpha rays originating from the radiation source and alpha rays originating from radon as explained below.

The detection unit 110, in each of a first period and a second period that is longer than the first period, using a first alpha-ray source (strong radiation source) having high intensity in the first period and using a second alpha-ray source (weak radiation source) having an intensity that is lower than the first alpha-ray source and equal to or lower than a threshold value in the second period, detects the first pulse signal s1 and the second pulse signal s2, in relation to the measurement target 55. Here, the radiation intensities of the strong radiation source and the weak radiation source are explained. The strong radiation source is an alpha-ray source with a threshold value set to from 1 to 2α/cm²/hr, for example. The weak radiation source is an alpha-ray source with a threshold value set to 10⁻²/cm²/hr, for example. The respective threshold values may be set to have a ratio of from about 1/100 to 1/200.

The analysis unit 112, as analysis, using the detection result in the first period and the detection result in the second period, simultaneously estimates alpha rays originating from the radiation source and alpha rays originating from radon, in relation to the measurement target 55.

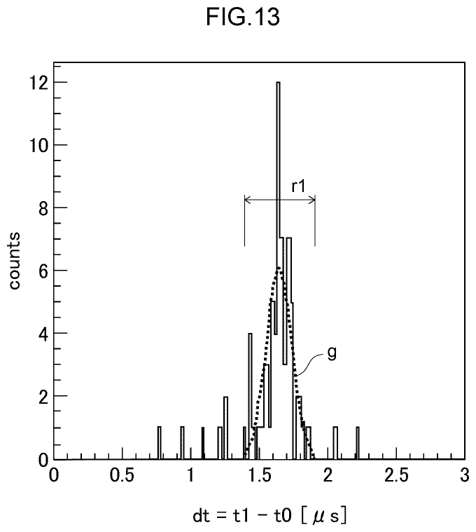

FIG. 13 shows the signal counts over a range of time differences measured for a short period of time using a strong radiation source. The signal count was determined by counting events in which the signal intensity in mV was equal to or greater than a threshold value. In the example of FIG. 13, the number of light emission events in the range dt=t1−t0 is counted in a case in which measurements are taken overnight (about 14 hours) using a strong radiation source. t1 is the end of s2, and t0 is the peak of s1. The curve (g) is an approximation curve of a Gaussian function. Measuring with a strong radiation source over a short period of time enables verification with a reduced influence from radon. Therefore, it can be estimated that the range in which r1 peaks constitutes the alpha rays originating from the radiation source.

The relationship between the drift velocity in the TPC and the verification conditions is explained. In the TPC, the relationship between voltage (kV), distance (cm), and air pressure (atm) is defined as EP=kV/cm/atm. For this relationship, see FIG. 4 in Reference Document 1 noted below. Further, a drift velocity V (cm/μs) is specified for the EP. In a case in which the verification conditions are set as application of 2.0 kV, a drift length of 15 cm, and 0.2 atmospheres, EP=2 kV/15 cm/0.2=0.6667. In this case, the drift velocity V is calculated as V(EP=0.6667 kV/cm/atm)=9.47 cm/μs. The time due to the drift velocity is 15 cm/9.47 cm/μs=1.59 μs. Looking at the peak in FIG. 13, it is a general peak at a speed that corresponds to the drift speed of the TPC. Therefore, it can be read that the drift velocity using the time difference dt can be determined with high accuracy. However, since the time constant of the μ-PIC signal is slow, there is the problem that it is difficult to capture the time difference.

### [Reference Document 1] Nuclear Instruments and Methods in Physics Research A 324 (1993) 113-126

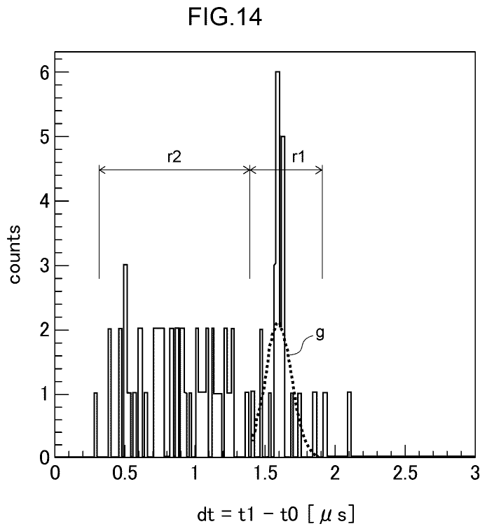

FIG. 14 shows the signal counts of ranges of time differences measured for a long period of time using a weak radiation source. In the example of FIG. 14, the number of light emission events in the range dt is counted in a case in which measurements are taken over two weeks (about 336 hours) using a weak radiation source. The distribution is continuous within the time difference range, and it is estimated that alpha rays originating from radon are uniformly present in the container. It can be estimated that the r1 range is alpha rays originating from the radiation source, and the r2 range is alpha rays originating from radon. The 14-hour period in the example of FIG. 13 is an example of the first period of the present disclosure, and the long period of two weeks in the example of FIG. 14 is an example of the second period of the present disclosure. Since, in the detection result in the first period, the range of r1 is detected, and in the detection result in the second period, the range of r2 is detected, the alpha rays originating from the radiation source and the alpha rays originating from radon can be simultaneously estimated from the differences between the respective detection results. Here, in a case in which measurements were taken over 670 hours, which is more than two weeks, a distribution similar to that of the case of two weeks was obtained. The second period is not limited to the example of two weeks, but can be adjusted as appropriate depending on the amount of alpha rays generated by the measurement target. In this way, the analysis unit 112 removes alpha-ray events originating from radon from each detection result. By using the detection results after removal, the position of the z coordinate in the height direction is accurately obtained.

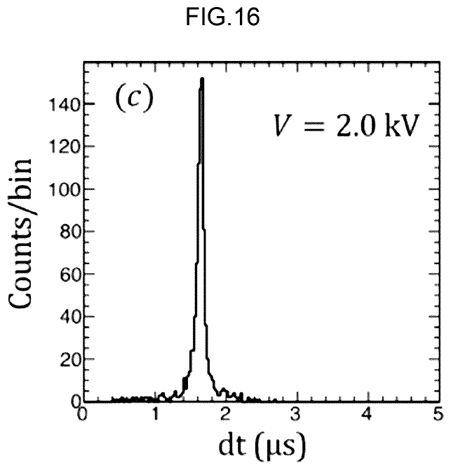

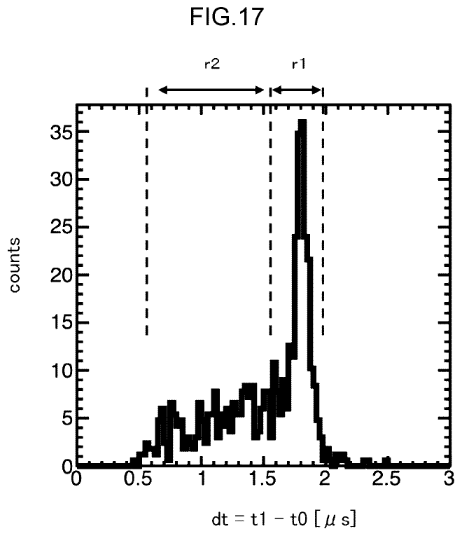

An experimental example is exemplified of a case in which the statistical amounts of the detection samples are increased. FIG. 16 shows the signal counts of a range of time differences measured for a short period of time using a strong radiation source with an increased statistical amount. In the example of FIG. 16, the signal counts are counted over a 24-hour period. By increasing the statistical amount in a performance test using an alpha-ray source of from 1 to 2 α/cm²/hr, a clear peak structure originating from the alpha-ray source can be observed. With the average time difference dt=1.641 μs and drift length=15 cm, the drift velocity v=15 cm/1.641 μs=9.16 cm/μs. FIG. 17 shows the signal counts over a range of time differences measured for a long period of time using a weak radiation source with an increased statistical amount. In the example of FIG. 17, the signal counts are counted over one month. In a performance test using an alpha radiation source of 10⁻²/cm²/hr, compared to the case shown in FIG. 15, an example of detection result was obtained in which radon-derived (r2) and sample-derived (r1) could be clearly separated.

As explained above, in the analysis device 1 according to the present embodiment, the housing 50 is filled with CF₄ gas, a first pulse signal s1 of primary light emission and a second pulse signal s2 of secondary light emission due to the action of radiation generated by the measurement target 55 and CF₄ gas molecules are detected, and the generation position of the radiation source is estimated using the time difference of the signals. Radiation generated by the measurement target 55 inside the housing 50 can be detected with high accuracy.

However, there is no limitation to a TPC, and any kind of chamber may be used as long as it has an anode electrode, such as an ionization chamber or a proportional counter, which induces electrons to cause avalanche amplification and generates the second pulse signal s2. Further, there is no limitation to a μ-PIC, and GEM, Micro-Megas, and the like may be used.

Further, while an emission wavelength region of 400 nm is usually used for scintillation emission, there is no limitation to this, and the near infrared region may also be used. Further, the optical sensor is not limited to a PMT.

Since metals such as lithium absorb neutrons and generate alpha rays, they can also be used to measure extremely low-activity neutrons.

Although embodiments of the present disclosure have been described in detail above with reference to the accompanying drawings, the technical scope of the present disclosure is not limited to such examples. It will be evident that a person having ordinary skill in the technical field of the present disclosure can conceive of various modifications or alterations within the scope of the technical concepts recited in the claims, and it will be understood that these modifications and alterations are, of course, within the technical scope of the present disclosure.

Further, the effects described in the foregoing embodiments are explanatory or exemplary, and there is no limitation to those described in the foregoing embodiments. That is, the technique of the present disclosure may exhibit other effects that are apparent to a person having ordinary skill in the technical field of the present disclosure from the description in the foregoing embodiments, in addition to or in place of the effects described in the foregoing embodiments.

The disclosure of Japanese Patent Application No. 2023-044723 filed on Mar. 20, 2023, is incorporated herein by reference in its entirety. All documents, patent applications, and technical standards described in the present specification are incorporated by reference in the present specification to the same extent as if the individual documents, patent applications, and technical standards were specifically and individually stated to be incorporated by reference.

### EXPLANATION OF REFERENCE NUMERALS

1 ANALYSIS DEVICE
10 VACUUM PUMP
20 CF₄ GAS CYLINDER
30 PRESSURE MEASUREMENT DEVICE
40A, 40B VALVES
50 HOUSING (CONTAINER)
51 GAS
56 PLACEMENT PART
58 M-PIC (ANODE ELECTRODE)
60A, 60B PHOTOMULTIPLIER TUBES (LIGHT SENSORS)
70 STORAGE UNIT
110 DETECTION UNIT
112 ANALYSIS UNIT

1. An analysis device, comprising:
a gas that emits scintillation light, and that ionizes to generate secondary electrons, under the action of gas molecules and radiation in a container;
a predetermined optical sensor that generates a pulse signal in response to receiving the scintillation light;
a detection unit that detects the pulse signal generated by the optical sensor;
an electrical field that transports the ionized secondary electrons in the container; and
an analysis unit that, based on the pulse signal, performs analysis in relation to a radiation source that is a measurement target and that is a generation source of the radiation, wherein:
an anode electrode is provided that is disposed in a direction in which the secondary electrons are transported and that detects the secondary electrons,
the detection unit detects a first pulse signal generated by the optical sensor upon receipt of excitation emission of the gas molecules generated from the radiation at a time at which the radiation is emitted from the measurement target, and detects a second pulse signal generated by the optical sensor upon receipt of light emitted by avalanche amplification of a group of the secondary electrons each time that the secondary electrons move to the anode electrode while maintaining a trajectory of the radiation as a result of the electric field and the group of secondary electrons, which is track-shaped, arrives at the anode electrode, and
the analysis unit, as the analysis, estimates a generation position of the radiation source based on a time difference between the first pulse signal and an end of the second pulse signal.

2. The analysis device of claim 1, wherein the analysis unit:
for the second pulse signal, identifies an end point of a signal that is a preset threshold value or lower, that varies depending on the radiation, and that depends on a direction of the radiation, and
based on a time difference between a peak of the first signal and the identified end point of the second pulse signal, calculates a drift velocity of the secondary electrons, and estimates a z-coordinate of the radiation source by calculating a distance from the anode electrode to a radiation emission point from the drift velocity and the time difference.

3. The analysis device of claim 1, wherein:
the detection unit, in each of a first period and a second period that is longer than the first period, detects the first pulse signal and the second pulse signal with respect to the measurement target using a first alpha-ray source in the first period and using a second alpha-ray source having an intensity that is lower than the first alpha-ray source and equal to or lower than a predetermined threshold value in the second period, and
the analysis unit, as the analysis, simultaneously estimates, relative to the measurement target, an alpha-ray event originating from the radiation source and an alpha-ray event originating from radon, using a detection result in the first period and a detection result in the second period, and removes the alpha-ray event originating from radon from each of the detection results.

4. The analysis device of claim 1, wherein the gas is an inert gas.

5. The analysis device of claim 4, wherein carbon tetrafluoride, argon, neon or xenon is used as the inert gas.

6. The analysis device of claim 1, wherein an atmospheric pressure of the gas, which is supplied into the container, is from 0.1 to 1.2 atmospheres.
